(19) United States
(12) Patent Application Publication
(10) Pub. No.: US 2024/0126746 A1
(43) Pub. Date: Apr. 18, 2024

(54) MULTI-LOB CACHING AND LOB WRITING

(71) Applicant: Oracle International Corporation, Redwood Shores, CA (US)

(72) Inventors: SHUBHA BOSE, Foster City, CA (US); DAVID PACHECO, Redwood City, CA (US); AUROSISH MISHRA, Foster City, CA (US)

(21) Appl. No.: 18/380,098

(22) Filed: Oct. 13, 2023

Related U.S. Application Data
(60) Provisional application No. 63/415,728, filed on Oct. 13, 2022.

(51) Int. Cl. G06F 16/23; G06F 16/22

(52) U.S. Cl. CPC G06F 16/2379; G06F 16/2219

(57) ABSTRACT

LOB cache swapping is reduced by multi-LOB writing. Under multi-LOB writing, information that tracks changes made by a database transaction to multiple LOBs is retained in a LOB staging buffer after one or more LOB switches. Thus, at commit time, changes to multiple LOBs in a column may be staged in the LOB staging cache, thereby enabling the changes to be made in contiguous data blocks for all the multiple LOBs. Storing LOBs in the same column in this way improves clustering, thereby improving database performance. In addition, LOBs inserted or updated in the same database transaction are often related and accessed together within database transactions and/or query accesses. Clustering the LOB content of such related LOBs allows the LOBs to be accessed more efficiently.

### BENEFIT CLAIM

This application claims the benefit under 35 U.S.C. § 119(e) of provisional application 63/415,728, filed Oct. 13, 2022, by Shubha Bose et al., the entire contents of which is hereby incorporated by reference.

### FIELD OF THE INVENTION

The present disclosure relates to modifying large objects in a DBMS.

### BACKGROUND

A DBMS is an important mechanism for persistently storing, accessing and otherwise managing many types of data. In a relational DBMS, data is stored as rows having attributes in the form of columns. Each column has a datatype, which may be a scalar value, an object type instance having attributes, or a large binary object (lob).

Rows are stored persistently in data blocks. For many data types, column values of a row are stored “inline” in the same data block. To modify a column value in a row that is stored in a data block, a DBMS reads the data block from persistent storage and stores a copy of it in a database buffer, where the column value is modified in place within the row and copy of the data block.

FIG. 1 depicts an illustrative DBMS used to illustrate the modification of inline column values by a DBMS. Referring to FIG. 1, DBMS 101 includes a database server 110 and database persistent storage 120. Data blocks for database objects (e.g. tables) of DBMS 101 are persistently stored in database persistent storage 120.

To modify a column value in a row that is stored in a data block, a DBMS reads the data block from database persistent storage 120 and stores a copy of it in database buffer 112, where the column value is modified in place within the row in the data block. When a modification is made to a data block, DBMS 101 generates one or more redo and undo records and stores them in log buffer 114.

In general, database changes are made to data blocks by database processes executing a transaction. Redo and undo records record changes made by a transaction. One or more redo records and one or more undo records may be referred to herein as redo or undo, respectively. In DBMS 101, a transaction may be committed once the redo and undo generated by the transaction are written from log buffer 114 to persistent log 116, or are otherwise stored persistently. Afterward, the data blocks are written from database buffer 112 to database persistent storage 120.

Some database changes may require storing data in a “new” data block, or more accurately, a data block not yet used to store database data. Allocated data blocks are data blocks that are being used to store database data, such as rows for a table. Unallocated data blocks are data blocks that are not being used to store database data but that are available to be used to store database data once allocated. To store data in an unallocated data block, DBMS 101 examines free space mapping 118 to find an unallocated data block in database persistent storage 120. A free space mapping identifies allocated or unallocated data blocks in database persistent storage. Once DBMS 101 identifies an unallocated data block by examining free space mapping 118, DBMS 101 alters free space mapping 118 to mark the data block as allocated, creates a copy of the data block in the database buffer, and stores data required for the database changes in the data block. The data block created may be referred to herein as a new data block.

The term database write is used to refer to operations to make changes to content in data blocks stored in persistent storage by, inter alia, making a change to a copy of the data block in the database buffer and generating redo records and/or undo records. Ultimately, the copy of the data block is stored as a new version of the data block in persistent storage. A database write does not necessarily include writing a data block to persistent storage. A database transaction may specify multiple database commands that each cause a separate database rewrite and separate redo and undo records for the same data block. When the data block is ultimately written to persistent storage, the new version of the data block reflects the database writes. In general, changes to inline column values are made to data blocks by performing database writes. A database write may modify multiple data blocks.

### LOBs

LOBs can comprise large amounts of data and therefore are often stored “out-of-line”. A column is stored out-of-line when column values of the column are not stored in the set of data blocks that primarily store inline column values of other columns of the rows of a table. Column values of an out-of-line column are stored in a separate set of data blocks assigned to store column values of the out-of-line column.

Not only can LOBs contain large amounts of data, but changes made to LOBs can also affect large amounts of data, which creates issues that will be explained later. Measures undertaken to deal with these issues include staging the changes to the LOBs before performing database writes. Before further explaining how the LOB changes are staged, it is helpful to describe the structure of a LOB and how changes are made to column values.

FIG. 2 illustrates a LOB contained in a LOB column of a table row, according to an embodiment of the present invention. Referring to FIG. 2, data block 210 stores a subset of rows for a table and, for each of the rows, the inline column values for the inline columns of the table. In addition, the table includes a LOB column, which is stored out-of-line of the rows. For a LOB column of a row that stores the LOB out-of-line, the row holds a reference to the LOB, as illustrated in greater detail by row 212. Row 212 holds a LOB reference to LOB 220, that is, to the data blocks that store the content of LOB 220. Specifically, a LOB reference refers to a LOB meta block, which includes a mapping to one or more sets of data blocks that store content “LOB content blocks” for the LOB. The LOB reference of row 212 refers to LOB meta block 222, which contains a LOB mapping that maps LOB content block sets 224 and 226 as storing content for LOB meta block 222.

### Changing LOBs in a DBMS

To describe how a LOB is changed in a database, it is useful to compare how LOBs and scalar type columns are changed in a DBMS. Generally, modifications to scalar values are made in response to database commands that specify the modifications using whole-value-assignment semantics. Such database commands specify an entire value to which set a column or column object attribute value of a row. For example, a DML command may specify an update to columns of an existing row by specifying, for each column, the entire column value to which to set the column for that row.

DML commands to change column values can be submitted to a DBMS for execution by invoking a call within a database session and database transaction to execute the command. Such calls are referred to herein as database calls. A database call made to execute a DML command may generate one or more database writes.

A LOB, on the other hand, is modified by issuing commands to the DBMS that specify changes using “offset semantics”. In offset semantics, offset-based database commands specify an offset and a range to modify within a LOB.

In a process referred to herein as LOB staging, the changes specified by offset-based database commands made by a database transaction to a LOB are tracked within a LOB staging cache, but changes to underlying LOB content blocks are deferred until, for example, commit time. The changes may append new content to a LOB or modify existing LOB content in existing LOB content blocks of the LOB. LOB content and a LOB content block are referred to as existing with respect to a database transaction if the LOB content is committed and stored in the LOB content block when the database transaction is initiated.

At commit time, new LOB content blocks are generated for new LOB content. However, modifications to existing LOB content data blocks are effected in two ways. Modifications may be performed “in-place” by modifying the existing LOB content blocks themselves. Or, the modifications may be performed “out-of-place” in a new LOB content block instead of the existing LOB content blocks through a process referred to as retention.

Under retention, new LOB content data blocks are created to in effect replace the existing LOB content data blocks as new versions of the existing LOB content data blocks. The existing LOB content blocks are retained and referred to herein as retained data blocks. The LOB mapping in the LOB meta block is changed to map the new LOB content blocks in place of the respective retained data blocks. Database writes are performed to create the new LOB content data blocks.

The advantage of creating new LOB content blocks instead of modifying the retained data blocks is that undo records that would otherwise be generated is avoided if the retained data blocks were instead changed in-place. Because of the scale of some data size changes to LOB s, generating undo records for the changes could require storing a lot of undo records that hold a large volume of data. Retention avoids generating such undo records.

Undo records are also recorded for new data blocks. However, undo records created for new data blocks require little data because database content was not previously stored in the new data blocks.

The retained data blocks are used for consistent reads because the retained data blocks are in effect repurposed to provide data needed for consistent reads that would have otherwise been provided by undo records. Under consistent read, reads of database data during the execution of one or more database commands by a database transaction return data that is consistent with an SCN (system change number) associated with the database transaction. The SCN is referred to herein as a snapshot time. Transactional consistency in general requires that reads reflect only transactions committed before the SCN.

Undo records are used to reverse or undo changes made by a database transaction to a data block. Undo records are also used to provide transactional consistency. Each undo record is associated with an SCN. For data blocks that are read by a database session, a DBMS applies the needed undo records to copies of the data blocks to bring the copies to a state that is consistent with the snapshot time.

To provide transactional consistency for a LOB, an undo record is applied to the LOB's meta block to render the LOB meta block consistent with the snapshot time. As a result, the LOB mapping of the LOB meta block maps the LOB content data blocks of the LOB that were committed at or before the snapshot time, which may include the retained data blocks but not the respective data blocks that replaced the retained data blocks.

Another advantage of retention is that data block clustering for LOBs is improved. Data block clustering refers to storing data blocks of a subset of one or more LOBs in contiguous data blocks. Clustering is improved when a subset of one or more LOBs is stored in a smaller number of sets of contiguous blocks. Data block clustering improves the efficiency of accessing LOB content. The opposite of clustering is fragmentation, in which a larger number of smaller sets of contiguous data blocks store a set of LOBs.

Because new LOB content blocks may in effect be written together in a set of one or more database writes at commit time, a set of contiguous data blocks can be found in the free space mapping for the new LOB content blocks. If instead database writes were performed for each LOB change call prior to commit time, the allocation of new data blocks for the changed LOB may be interleaved with the allocation of new data blocks for many other database transactions executing within the DBMS. As a result, a larger number of new LOB content blocks generated for a single database transaction are not written in a set of contiguous data blocks, thereby increasing fragmentation.

Clustering is reduced by a phenomenon referred to as LOB cache swapping. LOB cache swapping occurs when LOB change calls to multiple different LOBs are interleaved within a database transaction. A LOB change call that is directed to a different LOB than the one for which changes are currently being staged in the LOB staging cache is referred to herein as a LOB switch.

Changes staged for the LOB are flushed from the LOB staging cache in response to a LOB switch. A flush entails performing database writes to change LOB content in-place or to create new LOB content blocks for appended new LOB content or for LOB content being modified out-of-place. When the LOB that was flushed is then targeted by a subsequent LOB change call in the database transaction, the LOB staging cache is flushed as before and new changes for the LOB are staged in the LOB staging cache, which creates additional new LOB content blocks for the LOB. However, the additional new LOB content blocks will likely not be stored contiguously with previous new LOB content blocks written for the database transactions. Fragmentation of the LOB content blocks of the LOB is thereby increased. Obviously, the more LOB cache swapping that occurs, the more fragmentation may increase.

Described herein is an approach for reducing fragmentation and improving the clustering of LOB content blocks.

### BRIEF DESCRIPTION OF THE DRAWINGS

In the drawings:

FIG. 1 is a diagram depicting a DBMS according to an embodiment of the present invention.

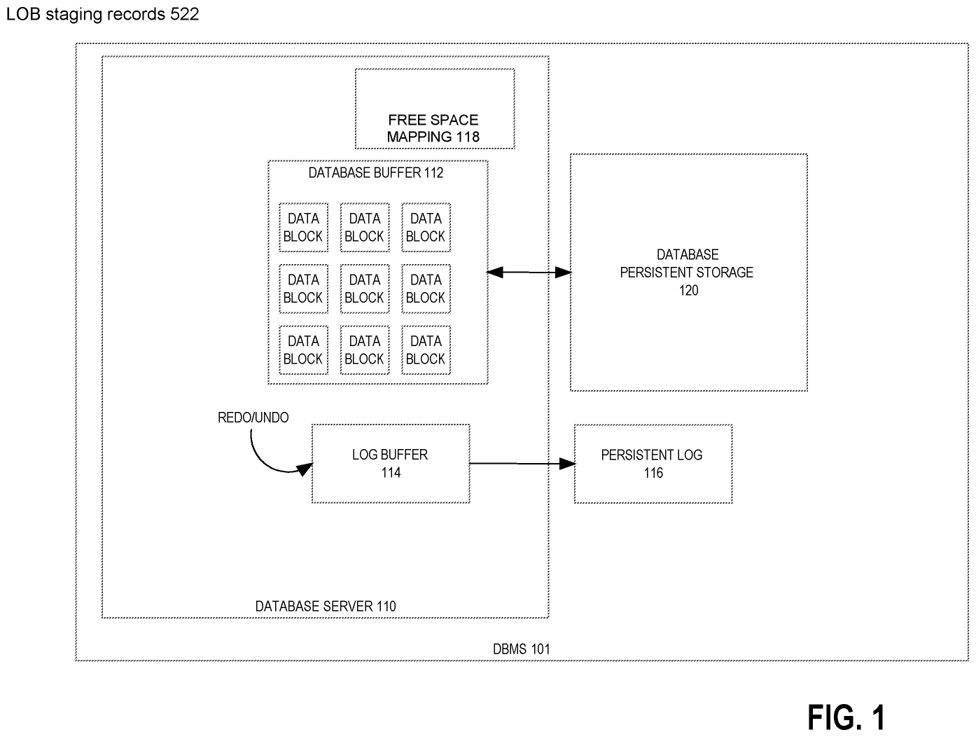

FIG. 2 is a diagram depicting storage of inline column values and a LOB of a table row, according to an embodiment of the present invention.

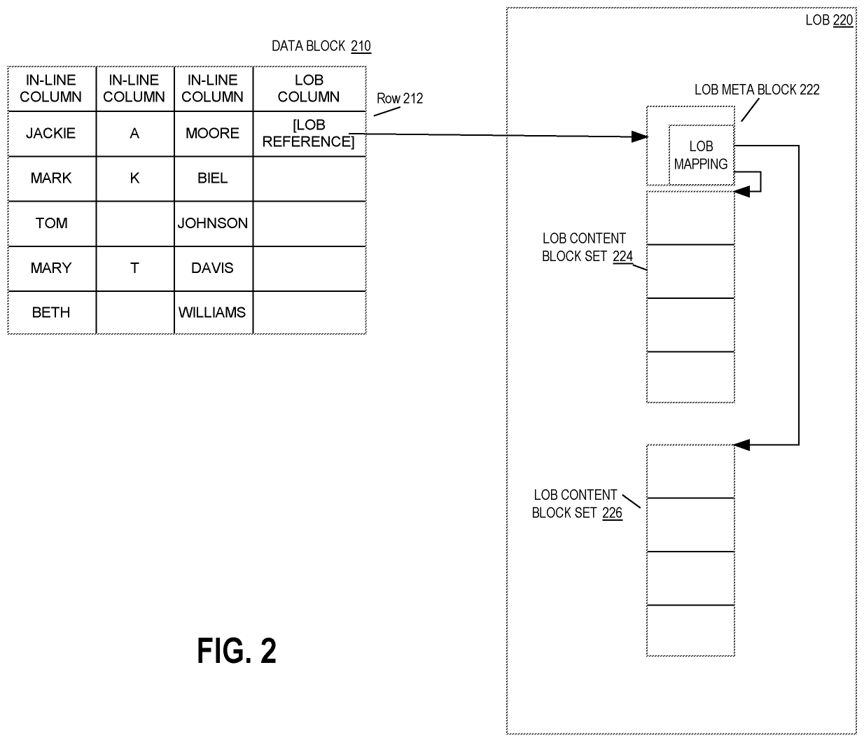

FIG. 3 is a diagram depicting staging of LOB changes according to an embodiment of the present invention.

FIG. 4 is a diagram depicting multi-LOB writing performed at commit time according to an embodiment of the present invention.

FIG. 5 is a diagram depicting a computer system that may be used to implement an embodiment of the present invention.

FIG. 6 depicts a software system that may be employed for controlling the operation.

### DETAILED DESCRIPTION

In the following description, for the purposes of explanation, numerous specific details are set forth in order to provide a thorough understanding of the present invention. It will be apparent, however, that the present invention may be practiced without these specific details.

### General Overview

Described herein is an approach referred to herein as multi-LOB writing that reduces LOB cache swapping. Under multi-LOB writing, information that tracks changes made by a database transaction to multiple LOBs is retained in a LOB staging buffer after one or more LOB switches. Thus, at commit time, changes to multiple LOBs in a column may be staged in the LOB staging cache, thereby enabling the changes to be made in contiguous data blocks for all the multiple LOBs. Storing LOBs in the same column in this way improves clustering, thereby improving database performance. In addition, LOBs inserted or updated in the same database transaction are often related and accessed together within database transactions and/or query accesses. Clustering the LOB content of such related LOBs allows the LOBs to be accessed more efficiently.

### Introduction LOB Staging

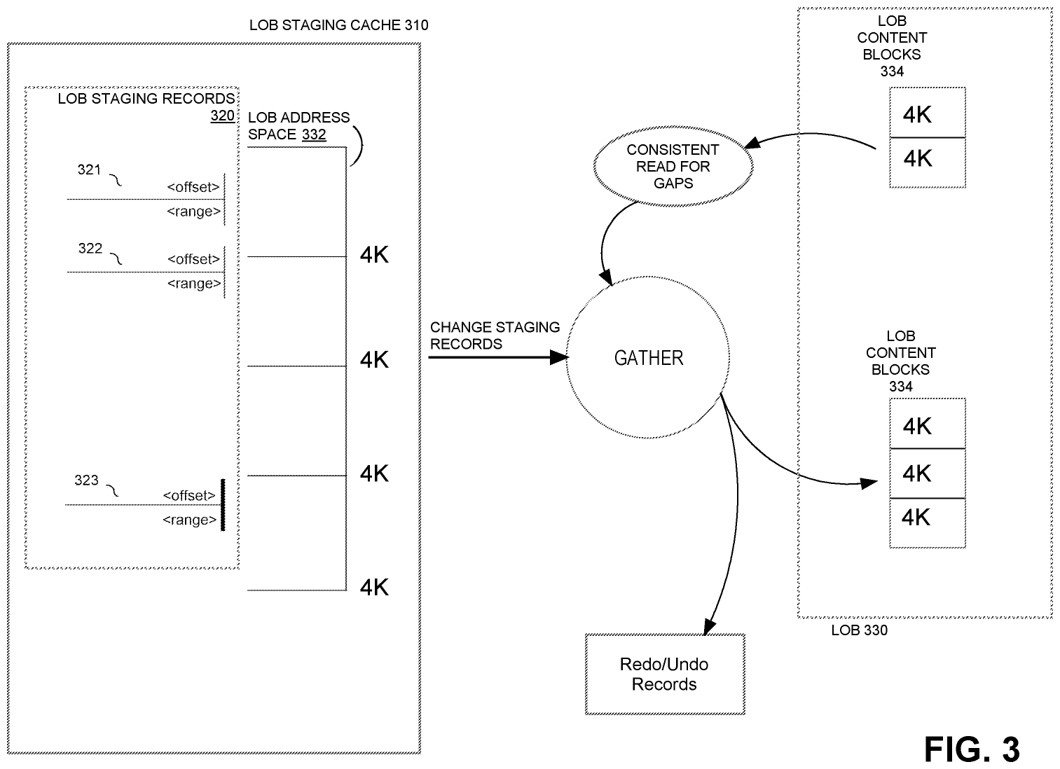

FIG. 3 depicts LOB staging performed to modify of single LOB within a database transaction. The following description of FIG. 3 is an introduction to how various aspects of LOB staging are represented and depicted herein and is useful for understanding LOB staging performed in the context of multi-LOB writing.

Referring to FIG. 3, it depicts LOB staging cache 310, which is being used to modify LOB 330 in a database transaction. LOB 330 is stored in LOB content blocks 334 when the database transaction is initiated. After the database transaction is committed, LOB content blocks 334 become retained data blocks and new LOB content blocks 334′ store content of LOB 330.

LOB staging records 320 record changes specified by LOB change calls within the database transaction. LOB staging records 320 include LOB staging records 321, 322 and 323. Each of these LOB staging records specifies an offset and range within the address space of a LOB, and replacement data to which to set that range within the LOB beginning at the offset. LOB address space 332 represents the LOB address space of LOB 330 with boundaries at 4K ranges within LOB address space 332. For example, a LOB staging record may specify to change LOB 330 at offset 1023 within LOB address space 332 for a range of a three to “XYZ”.

The length of vertical right bars of the depiction of LOB staging records 321, 322 and 323 in FIG. 3 corresponds to the respective offset and range of each of these LOB staging records. The emboldened right vertical bar for LOB staging record 323 denotes that the LOB staging record specifies new LOB content for LOB 330 that did not exist when the database transaction was initiated. On the other hand, the unemboldened right vertical bar for LOB staging records 321 and 323 denotes that each of these LOB staging records specifies a modification to LOB content of LOB 330 that existed when the database transaction was initiated.

A gather operation is performed at commit time to perform database writes that store changes specified by LOB staging records 320 to LOB 330. Based on LOB staging records for a LOB, a gather operation forms new versions of existing LOB content blocks for in-place changes and new LOB content blocks for out-of-place changes and new LOB content. The database writes also generate redo and undo records

In FIG. 3, changes to existing LOB content are being made out-of-place. Hence LOB content blocks 334 become retained data blocks and changes specified by LOB staging records 321 and 322 are made out-of-place within new LOB content blocks of LOB content blocks 334′.

LOB staging records 321 and 322 overwrite only portions of the existing LOB content and thus specify only some content of the new LOB content blocks. The ranges of existing LOB content not overwritten by LOB staging records are referred to here as gaps. To create the new LOB content blocks, the data for the gaps is retrieved by performing a consistent read of the existing LOB content blocks to retrieve data for the gaps. The retrieved gaps are combined with replacement data specified in the LOB staging records 321 and 322 to form the new LOB content blocks.

Data blocks occupy an address space referred to herein as a physical address space. The physical address space spanned by a data block is referred to herein as the physical data block size. The physical size of LOB content blocks 334 and 334′ is 4K.

In LOB address space 332, the range between each 4K boundary is referred to herein as a logical block. LOB content occupying a number of logical blocks is not necessarily stored in the same number of data blocks. Due to compression that may be performed by a gather operation, a lesser number of data blocks may be used to store LOB content that occupies a greater number of logical blocks. This is a reason the logical blocks in a LOB address space are referred to as logical and the LOB address space of a LOB may be referred to as a logical address space of the LOB. The logical size of the logical blocks within LOB address space 332 is 4K.

As shown in FIG. 3, the database transaction creates LOB content in LOB 330 that spans four logical blocks. However, due to compression performed during the gather operation, the new LOB content created by the database transaction is stored in three 4K LOB content blocks in LOB content blocks 334′.

The logical and physical block sizes described herein are illustrative. An embodiment of the present invention is not limited to any particular logical or physical block size.

### Mult-LOB Write at Commit Time

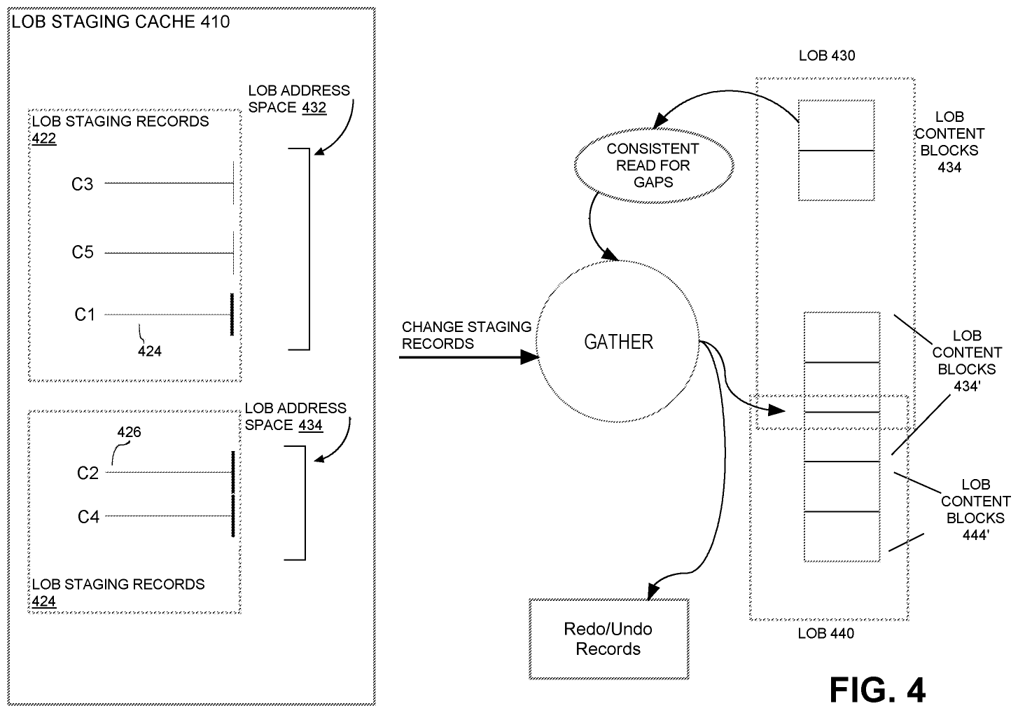

FIG. 4 depicts multi-LOB writing performed at commit time to change multiple LOBs. Referring to FIG. 4, it depicts LOB staging cache 410, which is being used by a database transaction to modify LOBs 430 and 440. LOB 430 is stored in existing LOB content blocks 434 when the database transaction is initiated. LOBs 420 and 440 are stored in the same segment.

After the database transaction commits, LOB content blocks 434 become retained data blocks and new LOB content blocks 434′ store changed LOB content of LOB 430. LOB 440 is a new LOB that is being created. LOB content for LOB 440 is stored in LOB content blocks 444. LOB content blocks 434′ and 444 are stored contiguously within a physical address space.

LOB staging records 422 and 424 record changes specified by LOB change calls within the database transaction. LOB staging records 422 record changes to LOB 430 and LOB staging records 422 record changes to LOB 440.

Each of the LOB staging records 422 and 424 are labeled with a call tag reflecting when the respective LOB change call of a LOB staging record is made relative to the respective LOB change calls of the other LOB staging records 422 and 424. LOB staging record 425 and 426 are labeled with call tag C1 and C2, respectively. The respective LOB change call of LOB staging record 425 was thus made before the respective LOB change call of LOB staging record 426.

Hereafter, a LOB staging record may be referred to herein by the respective call tag. For example, LOB staging record C1 refers to LOB staging record 425.

The database transaction includes LOB switches. A LOB switch occurs between C1 and C2, between C2 and C3, between C3 and C4, and between C4 and C5. However, LOB staging cache 410 is not flushed in response to these LOB switches.

A gather operation is performed at commit time to commit changes specified by LOB staging records 422 and 424 to LOBs 430 and 440, respectively. Changes specified by LOB staging records 422 to LOB 430 are being made out-of-place. Hence LOB content blocks 434 become retained data blocks and changes specified by LOB staging records 422 are made out-of-place and are stored in new LOB content blocks 434′. Changes specified by LOB staging records 424 to new LOB 440 are stored in LOB content blocks 444. The database writes performed to create LOB content blocks 434′ and 444 write these LOB content blocks contiguously. The database writes also generate redo and undo records.

Because LOB staging records for multiple LOBs are retained across LOB switches, a database transaction is able to request database writes that store new LOB content blocks for multiple LOBs in contiguous data blocks.

### Caveats

To flush of a LOB staging cache does, a gather operation is performed and then the LOB staging records in the LOB staging cache are removed. In multi-LOB writing, a LOB staging cache is flushed in response to a flushing event. Flushing events include (1) determining to commit and/or initiating commit operations and (2) filling the LOB staging cache with data up to a threshold limit. A LOB switch is or is not necessarily a flushing event.

In an embodiment, LOBs in a LOB column of a table may be stored across separate segments. For example, a table may be a partitioned table comprising multiple table partitions. For each partition, a DBMS may define a different segment for storing LOBs of a column. Thus, at commit time, when performing multi-LOB writing, a DBMS determines that a set of LOB staging records specify changes for LOBs stored in the same segment (and/or same column). In response to the determination, the DBMS performs database writes to create new LOB content blocks for the set of LOB staging records that are stored in contiguous LOB content blocks.

A database transaction may read LOB content. Database commands for reading LOB content also follow offset semantics. If a database command to read LOB content is covered by the respective range a LOB staging record in the LOB staging cache, the data in the LOB staging record is applied so that LOB content returned for the database command reflects changes specified by the LOB staging record.

A database transaction may set save points to which to roll back. In an embodiment, a LOB staging record is associated with save point that is current when the respective LOB change call is made. If the database transaction is rolled back to a particular save point, only any LOB staging records associated with save point at or less than the particular save point are applied to data returned for a database read command.

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snapshot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .java file) and the compiled version of the class (i.e. .class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

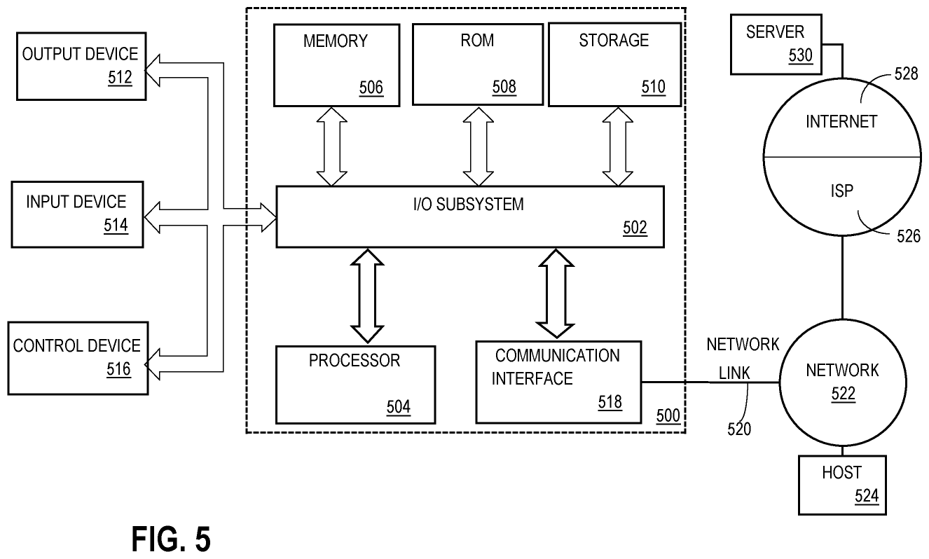

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

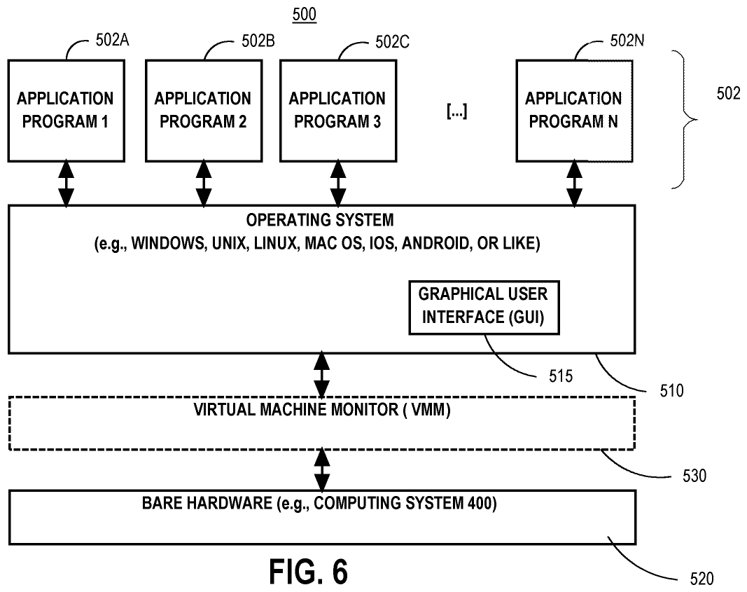

FIG. 6 is a block diagram of a basic software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method, comprising:
a DBMS executing a database transaction that makes changes to data blocks of a database;
said database transaction making a plurality of LOB change calls to change a plurality of LOBs;
in response to said plurality of LOB change calls, storing a plurality of LOB staging records in a LOB staging cache, each LOB staging record of said plurality of LOB staging records specifying a change to LOB content of a respective LOB of said plurality of LOBs;
said DBMS receiving a command to commit said database transaction;
in response to said DBMS receiving a command to commit said database transaction, performing commit time operations to commit said database transaction, wherein said commit time operations include:
executing a plurality of database writes to store content specified by at least a first set of LOB staging records of said plurality of LOB staging records in a plurality of LOB content blocks.

2. The method of claim 1, wherein:
said plurality of LOB staging records includes a first set of LOB staging records and a second set of LOB staging records;
performing commit time operations includes:
determining that said first set of LOB staging records and said second set of LOB staging records specify changes to particular LOBs that are stored in a same first segment; and
in response to determining that said first set of LOB staging records and said second set of LOB staging records specify changes to LOBS that are stored in a same first segment, storing LOB content blocks for said particular LOBs contiguously within said same first segment.

3. The method of claim 4,
wherein said plurality of LOB staging records includes a third set of LOB staging records that specify changes to a third LOB stored in a second segment; and
where executing a plurality of database writes includes executing a database write to store a LOB content block for said third LOB in said second segment.

4. The method of claim 1, wherein:
said plurality of LOB staging records includes a first set of LOB staging records and a second set of LOB staging records;
performing commit time operations includes:
determining that said first set of LOB staging records and said second set of LOB staging records specify changes to particular LOBs that belong to a same column;
in response to determining that said first set of LOB staging records and said second set of LOB staging records specify changes to LOBs that belong a same column, storing LOB content blocks for said particular LOBs contiguously.

5. The method of claim 4,
wherein said plurality of sets of LOB staging records includes a third set of LOB staging records that specify changes to a third LOB stored in a second column; and
where executing a plurality of database writes includes executing a database write to store a LOB content block for said third LOB in said second column.

6. The method of claim 1, wherein the method further includes:
determining that a threshold amount of data is stored in said LOB staging cache; and
in response to determining that a threshold amount of data is stored in said LOB staging cache, flushing said LOB staging cache.

7. The method of claim 6, wherein flushing said LOB staging cache includes executing a plurality of database writes to store content specified by a second set of LOB staging records of said plurality of LOB staging records in one or more LOB content blocks.

8. The method of claim 1, wherein before initiating said database transaction, said plurality of LOB staging records include a particular LOB staging record that specifies a change to a particular LOB content block, said particular LOB content block being retained after committing said database transaction.

9. The method of claim 1, further including in response to a database read command for a particular LOB, applying one or more LOB staging records of said plurality of LOB staging records that specify changes to said particular LOB to return data requested by database read command.

10. The method of claim 1, wherein:
each LOB staging record of said plurality of LOB staging records is associated with a save point of said database transaction;
the method further includes rolling back said database transaction to a particular save point; and
wherein applying one or more LOB staging records includes applying one or more LOB staging records based on the particular save point and one or more save points associated with said one or more LOB staging records.
